(19) United States
(12) Patent Application Publication
(10) Pub. No.: US 2011/0112992 A1
(43) Pub. Date: May 12, 2011

(54) OPPORTUNISTIC FULFILLMENT OF TASKS BY SUGGESTIONS FROM A PERSONAL DEVICE

(75) Inventors: JUAN LIU, MILPITAS, CA (US); KURT E. PARTRIDGE, PALO ALTO, CA (US); MAURICE K. CHU, BURLINGAME, CA (US)

(73) Assignee: PALO ALTO RESEARCH CENTER INCORPORATED, Palo Alto, CA (US)

(21) Appl. No.: 12/615,006

(22) Filed: Nov. 9, 2009

(51) Int. Cl. G06N 5/02; G06F 17/00

(52) U.S. Cl. 706/11; 706/47

(57) ABSTRACT

A computer tasking system has at least one sensor arranged to provide current location data for a user, an environment module to determine venues local to the user, a data repository having tasking data, and a recommendation module to analyze the current location data, the venues and the tasking data to produce a tasking recommendation for the user. A computer-controlled method of making recommendations of tasks includes receiving situational data from at least one sensor at a computer, accessing a repository of tasking data, determining, based upon the situational data and the tasking data, if an opportunity exists for task fulfillment, and making a recommendation to a user regarding the task fulfillment based upon the opportunity through a user interface. A shared task fulfillment system has a central hub consisting of a device that provides a user interface for entering a request for task fulfillment, the central hub comprising, a repository to store the request, a network interface to allow user devices to access the central hub, a processor to receive communications through the network interface and the user interface to update the repository and communicate with user devices, and a network of users having user devices.

### BACKGROUND

A large part of energy consumption lies in transportation. People commute to work, run errands, visiting family, etc. This consumes large amounts of energy in the form of fuel to operate the mode of transportation and consume large amounts of time as people move from one area to another. A capability of combining errands in a convenient and location-oriented way would be helpful to users and would conserve resources.

Some research has occurred in areas related to this type of capability including activity recognition, rhythm modeling, prediction of user transportation destinations, prediction of future locations, and using GPS (global positioning satellites) to learn significant locations for users.

Examples of activity recognition have been published as US Patent Publications. In one example, published as US Publication No. 20090073033, a system infers user activities based upon a trace of the user's location and a mapping of that location to a venue, such as a restaurant. A user's query is then received and given the context inferred from the user's location the system may provide a recommendation as to activities that can better match the user's preferences.

Other work related to people's movement and patterns involves “rhythm modeling” or methods of detecting and modeling a person's movements and activities using a database of online presence data. An example of such work is found in “Rhythm Modeling, Visualizations and Applications,” by Begole, et. al., Proceedings of the 16^{th} Annual ACM Symposium on User Interface Software and Technology, pp. 11-20, 2003.

Part of rhythm modeling involves predicting where a person will be or when the person will be at a particular locale. Other work in prediction of people's movements includes predicting a driver's route for location-based services by John Krumm and Eric Horvitz, “Predestination: Where Do You Want to Go Today?” IEEE Computer Magazine, vol. 40, no. 4, April 207, pp. 105-107.

Prediction of short-term activity patterns, such as daily activity patterns is discussed in “Predicting Future Locations Using Prediction-by-Partial-Match,” by Ingrid Burbey and Thomas Martin, Proceedings of the First ACM International Workshop on Mobile Entity Localization and Tracking in GPS-less Environments, pp. 1-6, 2008. Another example of such predictions, based upon GPS locations, can be found in, “Using GPS to Learn Significant Locations and Predict Movement Across Multiple Users,” Personal and Ubiquitous Computing, pp. 275-286, 2003.

Most of the location prediction work focuses on short-term prediction within minutes, hours or a day. Very little work exists on longer time horizons. In addition, much of the existing work is about predicting activities and locations, but not on opportunistic or energy-saving recommendations.

### BRIEF DESCRIPTION OF THE DRAWINGS

FIG. 1 shows an example of a mobile device in an opportunity for task fulfillment.

FIG. 2 shows an embodiment of a tasking system.

FIG. 3 shows a flow chart of an embodiment of a method of opportunistic task fulfillment.

FIG. 4 shows an embodiment of a system for opportunistic task fulfillment across a group.

FIG. 5 shows a flowchart of an embodiment of a method of opportunistic task fulfillment across a group.

### DETAILED DESCRIPTION OF THE EMBODIMENTS

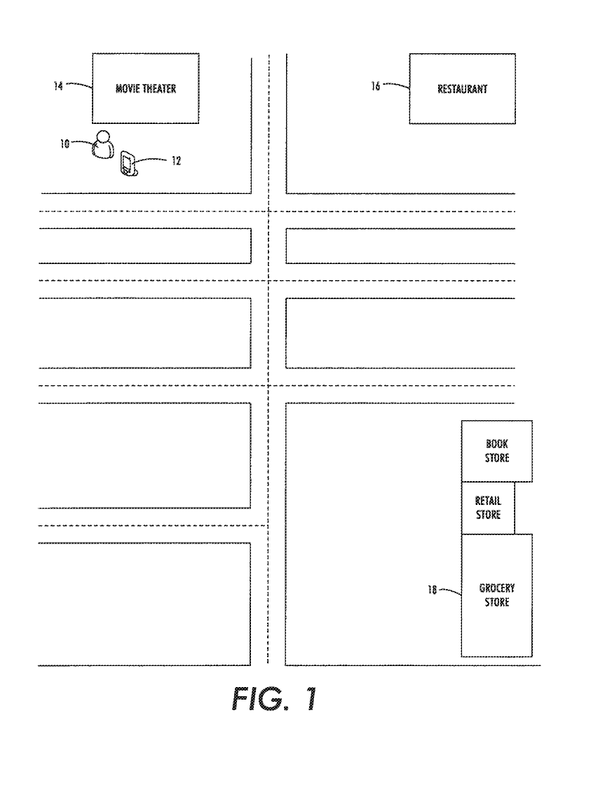

FIG. 1 shows an example of a user 10 having a mobile device 12 at an opportunity for task fulfillment. For example, assume the user 10 has exited a movie theater 14. The movie theater is not very far from a restaurant 16. Not as near, but still reasonably close, is a strip mall 18 with a book store, a retail clothing store and a grocery store. Maybe the user has limited time, or is energy conscious and typically tries to reduce the amount of driving to save on fuel.

It is possible for a tasking system, upon implementation of the embodiments here, to determine situational data, such as the user's location, using a Global Positioning Satellite (GPS) transponder is in the user's device. The system could then access tasking data, such as a calendar, to-do list, emails from particular people, etc., and determines that the user needs to pick up dinner, get a book for his daughter and go grocery shopping.

Using the situational data and the user's preference to save time, the device could make a recommendation that the user order dinner to go, and then drive to the strip mall, get the book, go grocery shopping and then pick up dinner and go home. If the user's preference is to save driving, the system may alter the order of recommendations to have the user start closer with dinner pick up and then recommend the trip to the book store and the grocery store on the way home. Either of these recommendations would save the user an extra trip, as may happen because the user forgot about the book and gets home only to have to go back out again, as well as taking the opportunity of the user's location to allow the user to consolidate errands, etc. saving time and fuel.

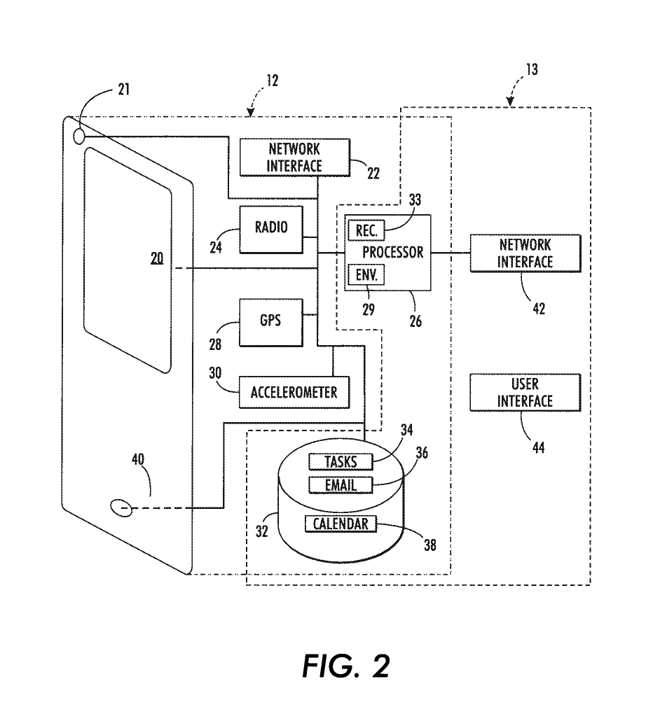

FIG. 2 shows an embodiment of a tasking system that can provide opportunistic task fulfillment recommendations. The system may divide the tasking between the user's device and a centralized server, such as in client-server architectures. For example, some embodiments may involve receiving situational data, such as the device's location or the user's current activity, directly from the device in a push-type interaction. Other embodiments may involve determining where the device is, in a more pull-type interaction.

Other components of the system, such as the tasking repository, or the processor that does most of the work may reside at the server, on the user's device, or shared between the two. For example, the tasking data may reside in the server, but the memory on the device may also be checked for any entries made by the user that have not been synchronized to the server yet. Similarly, the processing of the data may be shared between the two devices, with the server performing the bulk of the processing prior to producing the recommendation and the user's device doing the presenting of the recommendation to the user.

Components of the system will be discussed with regard to FIG. 2. Some of these components may reside on the user's device; others may reside on a server 13. The ‘shared’ components are shown in FIG. 2 as such, with the understanding that they may reside on the user's device 12, the server 13, or both. These shared components will be referred to as residing in the system.

The mobile device 12 may have several sensors, where the term sensor is broadly defined. This may include a wireless radio interface 21, such as a Wireless Fidelity (Wi-Fi) radio interface, or a cellular network radio interface as examples that detect the presence of a network and interface with the radio 24 and/or the network interface 22. The sensors may include a voice sensor or microphone 40 as well as light, temperature and other types of sensors.

An additional sensor may be an accelerometer such as 30 that detects the orientation of the device. Note that as used here, a device's orientation differs from its location. The orientation sensor, such as accelerometer 30, detects the orientation of the device such as in vertical or horizontal mode, while the location sensor, such as a GPS locator 28, detects the device's location on a grid or region. Using the network or radio interface, or a combination thereof, such as using the radio to access the Internet, the device could access several resources to assist with locating venues around the user that provide opportunities for task fulfillment, such as the grocery store discussed above. Alternatively, the network or radio interface may connect the device with the server 13 through the server's network interface 42, those resources residing on the server or the server handling the interfaces with those resources, as well as the detection of the device's position and orientation. The environment module 29 that performs these operations could reside on the user's device, on the server or be distributed between the two.

The processor 26 may determine the tasks to be fulfilled by accessing a repository 32 of data. Many systems employ calendar and task software such as Microsoft® Outlook® as an example. In addition, the system may also store emails 36 that can be parsed and analyzed to identify requests or to-do items sent from other people. This would provide the system with task to-do lists 34 and appointment data from the calendar 36. Further, the system may also track activities of the user.

Activity tracking may involve pattern identification, where the system would gather data related to the user's activities and then recognizing a pattern. For example, maybe the user spends an hour at a location every Saturday that corresponds with a grocery store. When the user is in a location near the grocery store on a Saturday, the system would use the activity data to provide a recommendation that the user go grocery shopping. The activity data plus any other data such as task to-do lists, calendar data, emails, etc., will be included in tasking data for purposes of the discussion here.

It must be noted that the device of FIG. 2 provides only one example of device working with a tasking system. The system could include any device having a processor capable of performing the analysis and provide recommendations and access to tasking data, whether located on the device or from a networked resource. Examples include cell phones, including ‘smart’ phones; networked notebook computer, typically referred to as ‘netbooks;’ personal digital assistants (PDAs), etc. No limitation is intended nor should any be inferred from any example given here.

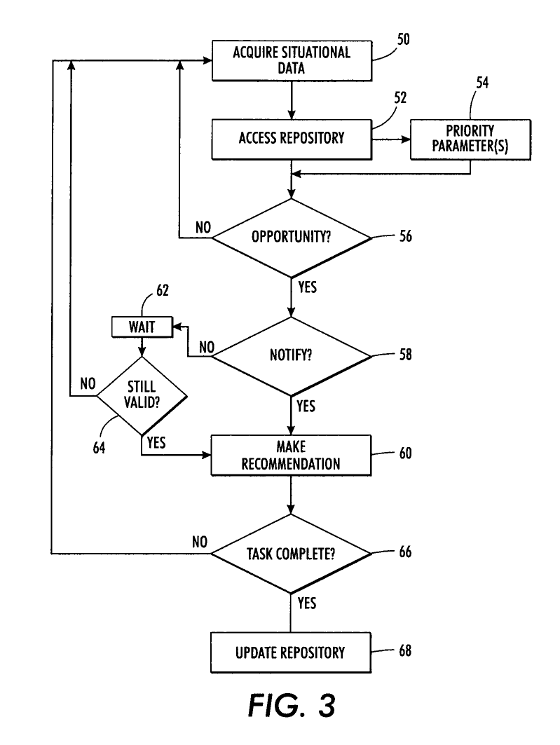

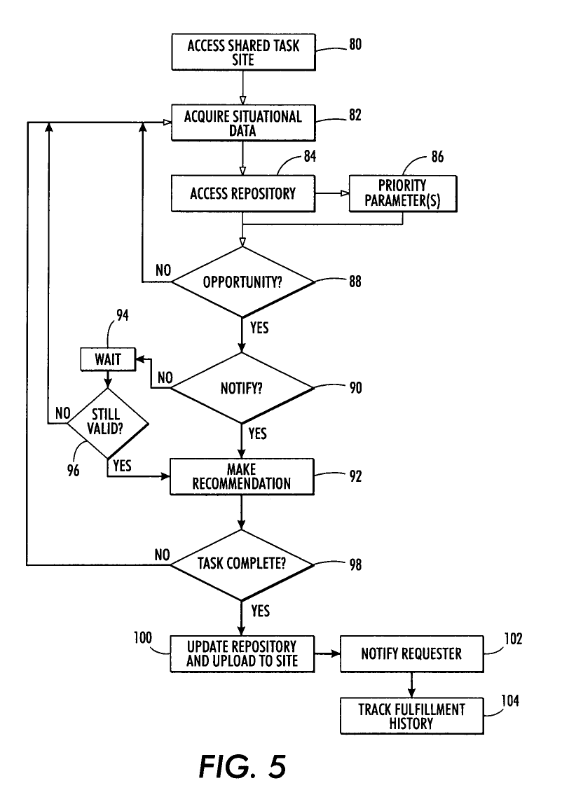

In operation, the system may analyze the tasking data to build a list of tasks to be fulfilled and then monitor the situational data to seek opportunities for fulfilling those tasks. Alternatively, the system may determine the situation first and then analyze the tasking data to determine if the situation provides an opportunity. In the discussions of FIGS. 3 and 5, these processes are shown in a sequence. However, the sequences provides one example and other sequences, as mentioned above, would be considered within the scope of the embodiments. The recommendation module 33 would operate on the user's device, on the server or distributed between the two.

FIG. 3 shows one embodiment of a method of making a recommendation for opportunistic task fulfillment. The system acquires situational data at 50. This data may include the user's location, the time, the temperature, the orientation of the device, etc. The situational data may also include accessing a mapping program, either on a network or local to the device, to determine an address of the mobile device and any resources or venues nearby.

At 52, the system accesses the repository of tasking data. As mentioned above, the system may have already analyzed the tasking data and developed a prioritized task list, or it may analyze the tasking data on the fly and determined a set of tasks that may be fulfilled based upon the situational data. The actual implementation is left up to the designer, as the processing capabilities, the type and format of tasking data, etc., may vary from system to system and what devices are included in the system.

Accessing the repository of tasking data may include accessing priority parameters given by the user at 54. The user would typically interact with the system through a user interface on a mobile device such as a combination of a display and a set of controls or a touch-screen, such as 20 from FIG. 2. However, the user may also interact with the communication system through a networked computer, in which case the user interface may be produced by the server 13, as shown at 44 FIG. 2.

When the user initially employs the capabilities provided by embodiments here, the user may provide inputs as to the priority with which tasks are to be sorted at 54. Examples include saving time, saving energy, a maximum number of tasks to be fulfilled in one outing, etc. In addition, the user may provide inputs as to times or situations during which recommendations should not be provided, such as within a half hour of having to be at an appointment, or when the user is at a movie or in church, etc. These inputs are referred to here as priority parameters.

The system gathers all of this data and then determines if there is an opportunity to fulfill a task at 56. This process may involve the system parsing through all of the tasking data and looking for keywords and then comparing the user's location and nearby resources and venues to match the keywords with them. If the system determines an opportunity exists, it may provide notification to the user immediately. Alternatively, the user may have set parameters or the system may determine that notification should not occur. This may be based upon the system recognizing that the user is attending a movie, is driving, is at an appointment, in church, or the time is within a particular window of an event for which the user set that the user did not want to be notified. If no parameter is set that limits notification, or if notification is allowed at 58, the system would make a recommendation at 60.

If the system determines that notification should not occur during that period of time, the system may wait at 62 until the time period expires, or the user moves outside a particular venue such as a movie theater or a church, etc. The system may then determine if the recommendation is still valid at 64. Possibly the task to be fulfilled may be time-dependent, such as when a particular store is open, etc. If the recommendation is still valid at 64, when the notification window opens up, the system would then make a recommendation at 60 through the user's mobile device.

Once the recommendation is provided at 60, the system would then determine if the user completed the task. This may be done explicitly, such as following up with directly with the user through the user interface. For the example, the mobile device may inquire of the user whether or not the user completed the task, or may leave a message on the user interface that is cleared when the task is complete. Alternatively, the device may work implicitly to mark a task as completed. If the device makes a recommendation that the user go grocery shopping, and the user's location changes to a location corresponding to a local Whole Foods™ store for a half hour, the system may implicitly determine that the task of grocery shopping is complete.

However it determines completion of the task at 66, if the system does makes that determination it would update the repository of tasking data to show the task as complete at 68. If the user does not complete the task, the process would return to the system monitoring the situational data to look for another opportunity to complete that or other tasks at 50.

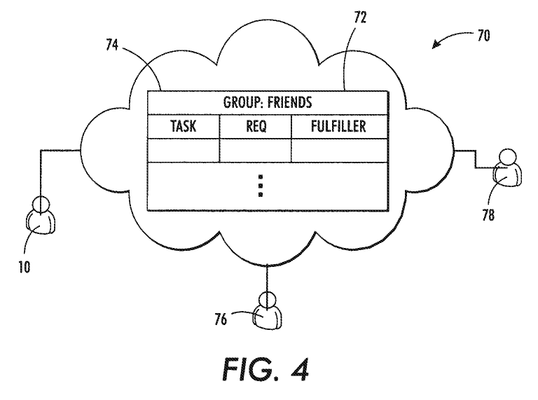

Having this capability provides the user opportunities to conserve resources, such as fuel, energy, time, etc., for that individual. This capability may also be employed across groups of people to allow users to cooperatively exchange errands, etc. across a group. FIG. 4 shows a system that provides that capability.

In FIG. 4, user 10 from FIG. 1 has now joined with users 76 and 78 to share tasks. As shown here, the users participate in a task sharing system 70. The task sharing system generally involves the users accessing a web site or server 72, which may be the same or similar server to 13 of FIG. 2, to request and log completion of tasks. A simplified version of a user interface for the group 74 shows the name of the group, a list of tasks and the requester, as well as the fulfiller. Users may belong to more than one group. For example, a user may belong to a group of parents all having children in a same classroom at school. A user may also belong to a group based upon the user's neighborhood. The web site would generally provide some sort of user profile and means to establish groups, and allow users to join and leave various groups.

Once joined to a group, the user could enter requests such as someone picking up items for that person at a home improvement supply store. The user may also make offers, such as ‘I am going to the grocery store tonight, does anyone need anything?’ The user may make arrangements with the store for the items to be pre-stacked and package so that the task fulfiller who picks up the items will not know what is in the package. The user's request may be ‘picked up’ by a person who indicates that person will fulfill the task, for example user 76. If user 76 does not fulfill the task for whatever reason, the user 76 may ‘drop’ the task back onto the list.

The example shown in FIG. 4 provides a very structured, centralized system for task fulfillment across groups. It is also possible that the task fulfillment across groups operates in a more informal environment, such as by broadcasted texted or emails lists and responses. One advantage to a more centralized approach lies in the ability to track fulfillments and user histories to ensure equity across the task sharing. The centralization may be a set of peers having the same application on their mobile devices, with one peer designated as the group leader, whose device becomes the central site, or hub, of the system.

Regardless of the overall system implementation, task fulfillment would typically operate very similarly to that of individual users. FIG. 5 shows an embodiment of a method of task fulfillment across a group. One difference between the group and individual implementations is that the user would access the shared task list at 80, either from the website or from an email, etc. This data would then become part of the user's tasking data. The system then acquires the situational data, accesses the repository that now includes shared tasking data and any priority parameters. As previously mentioned, while this sequence is shown as 80, 82, 84 and 86 in FIG. 5, these processes may occur in many different sequences and no limitation to any particular sequence is intended or should be implied.

The determination of an opportunity at 88 and the notification decision at 90 operate much as discussed at FIG. 3, including the optional portion of waiting and rechecking if the recommendation is still valid at 94 and 96. The system makes the recommendation at 92. If the system determines that the task is completed at 98, either implicitly or explicitly as discussed above, the completion is saved in the repository and/or uploaded to the site, if a central site is used at 100. The upload may take place upon completion of the task automatically or after receiving of confirmation from the user. The upload may also occur automatically, at a particular time designated by the user, upon user request, or the system could ask the user if the user wants the data uploaded and allow the user to affirm or deny the upload at that time. These are just some examples of updating the site to reflect the task fulfillment. In the de-centralized approach mentioned above, the completion may be noted as a broadcast text or email message notifying that the task has been completed.

The mechanism used to track the task fulfillment across the group may then notify the requester at 102. Again, this may result from a more formalized approach. In a more informal system the user that fulfilled the task may notify the requester with a phone call. As mentioned above, having a central point at which the task request and fulfillment data is tracked at 104, even if is it just one user's phone within the group, may allow the users to monitor usage for equity. Other user's may decide, on a peer level, not fulfill any more tasks for a user that has had several tasks fulfilled but does not fulfill any tasks. Alternatively, a more formal system may prevent or allow users to requests tasks based upon a credit system in which credits are earned for fulfilling tasks and are ‘spent’ for requesting tasks.

Other modifications and variations are of course possible. For example, the individual user recommendations may not always revolve around work or family related tasks such as groceries, etc. The tasking data may include information about activity levels and make recommendations with regard to leisure activities like going to a park, seeing a show, going bowling, etc. While those events and preferences may be referred to as ‘tasks’ they may not be tasks in the traditional sense of the word. One could imagine a user planning a vacation and making a list of attractions or sites to see or activities to do and the device providing recommendations based upon where the user is during vacation. If the user wanted to dive a coral reef while on vacation and the device may make a recommendation when the user is in a region that has several dive shops at some point in the vacation.

One of the advantages of such a system and its operation is the ability to use and make recommendations on data that relate across a longer time horizon than one day. Referring back to the example of grocery shopping, that recommendation is based upon a past pattern plus recognition of a weekly, not a daily, habit of the user.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A computer tasking system, comprising:
at least one sensor arranged to provide current location data for a user;
an environment module to determine venues local to the user;
a data repository having tasking data; and
a recommendation module to analyze the current location data, the venues and the tasking data to produce a tasking recommendation for the user.

2. The computer tasking system of claim 1, further comprising a user interface arranged to communicate the recommendation to a user.

3. The computer tasking system of claim 1, wherein the sensor comprises at least one of an accelerometer, camera, microphone, global position satellite locator, and Wireless Fidelity broadcaster.

4. The computer tasking system of claim 1, wherein the data repository having tasking data includes at least one of a to-do list, a calendar, a task list, completed task data, and an email message storage.

5. The computer tasking system of claim 1, further comprising a repository of historical data on previous activities of the user.

6. The computer tasking system of claim 1, wherein the recommendation module also analyzes the historical data to produce a tasking recommendation.

7. The computer tasking system of claim 1, wherein the repository also has priority parameters for the user.

8. A computer-controlled method of making recommendations of tasks, comprising:
receiving situational data from at least one sensor at a computer;
accessing a repository of tasking data;
determining, based upon the situational data and the tasking data, if an opportunity exists for task fulfillment; and
making a recommendation to a user regarding the task fulfillment based upon the opportunity through a user interface.

9. The computer-controlled method of claim 8, further comprising:
requesting a priority parameter from a user related to the task fulfillment;
receiving the priority parameter from the user interface; and
using the priority parameter in determining if an opportunity exists for task fulfillment.

10. The computer-controlled method of claim 8, further comprising determining whether the recommendation should be provided to the user prior to making the recommendation to the user based upon a current state of the user.

11. The computer-controlled method of claim 10, wherein determining whether a recommendation should be made is based upon a time of recommendation, a location of the user, or an occasion.

12. The computer-controlled method of claim 8, wherein accessing a repository of tasking data comprises accessing a repository of shared tasking data.

13. The computer-controlled method of claim 12, wherein the tasking data includes tasking data for at least one person other than the user.

14. The computer-controlled method of claim 13, wherein the task fulfillment is associated with the other person.

15. The computer-controlled method of claim 14, further comprising tracking task fulfillment by person.

16. The computer-controlled method of claim 15, further comprising presenting a history of task fulfillment by the user and by the other person to the user through the user interface.

17. The computer-controlled method of claim 8, further comprising recording whether the user fulfilled the task and storing the task fulfillment in the repository of tasking data.

18. The computer-controlled method of claim 8, wherein the tasking data includes both historical and prospective data.

19. A shared task fulfillment system, comprising:
a central hub consisting of a device that provides a user interface for entering a request for task fulfillment, the central hub comprising;
a repository to store the request;
a network interface to allow user devices to access the central hub; and
a processor to receive communications through the network interface and the user interface to update the repository and communicate with user devices; and
a network of users having user devices.

20. The shared task fulfillment system of claim 19, wherein the central hub is a server accessible by a web site.

21. The shared task fulfillment system of claim 19, wherein the central hub is a user device of a user member of the group.

22. The shared task fulfillment system of claim 19, wherein the network of users are organized into at least one group, wherein task requests are shared from the central hub across the group.
